(19) United States
(12) Patent Application Publication
(10) Pub. No.: US 2018/0188580 A1
(43) Pub. Date: Jul. 5, 2018

(54) TOUCH DISPLAY SCREEN AND ELECTRONIC APPARATUS USING THE SAME

(71) Applicant: Wuhan China Star Optoelectronics Technology Co.,Ltd., Wuhan, Hubei (CN)

(72) Inventors: Hongsen ZHANG, Shenzhen, Guangdong (CN); Chung-chun CHEN, Shenzhen, Guangdong (CN)

(73) Assignee: Wuhan China Star Optoelectronics Technology Co., Ltd., Wuhan, Hubei (CN)

(21) Appl. No.: 15/125,180

(22) PCT Filed: Jul. 20, 2016
(86) PCT No.: PCT/CN2016/090606

§ 371 Date: Sep. 11, 2016

(30) Foreign Application Priority Data
Jun. 22, 2016 (CN) 201610458414.8

(51) Int. Cl. G02F 1/1333; G02F 1/1335; G06F 3/044; G06F 3/041

(52) U.S. Cl. CPC G02F 1/13338; G02F 1/133602; G06F 3/0414; G06F 3/0416; G06F 3/044

(57) ABSTRACT

The present disclosure provides a touch display screen, comprising a middle frame, a liquid crystal panel, a backlight module, a sheet conductor and force sensitive circuits; the liquid crystal panel and the backlight module are fixed within the middle frame, the liquid crystal panel is stacked on the backlight module, and the sheet conductor is stacked on the side of backlight module away from the side of the liquid crystal; wherein, a space is existed between the sheet conductor and the backlight module, the force sensitive circuits are integrated into the liquid crystal panel, and a capacitor structure is formed by both the force sensitive circuits and the sheet conductor. According to the touch display screen in the present disclosure, the space structure can be reduced efficiently from the accumulated tolerance to enable the embedded force touch display screen mass produced. The present disclosure further provides an electronic apparatus.

### CROSS REFERENCE TO RELATED APPLICATION

This application claims the priority of Chinese Patent Application No. 201610458414.8, entitled “Touch display screen and electronic apparatus using the same”, filed on Jun. 22, 2016, the disclosure of which is incorporated herein by reference in its entirety.

### FIELD OF THE INVENTION

The present disclosure is related to a touch apparatus, in particular to a touch display screen and an electronic apparatus.

### BACKGROUND OF THE INVENTION

Integrating force sensors can be applied in more potential uses at portable electronic devices (for example: smart phones, intelligent players, e-books, PDA, phablets and etc.) as touch display screens continue to develop; in addition, more potential controlling functions can be further achieved by activating applications, moving a screen cursor and etc. All actions can be controlled and achieved with voltage changes caused by little gestures.

Touch display screens can be divided into piezoresistive type, piezoelectric type, and capacitive type according to the principle; wherein the technology of capacitive type is more mature and the application of the capacitive type is the broadest. According to positions sensing electrodes are different in the touch display screen of capacitive type, the technology of capacitive type can further be divided into traditional force touch technology and new embedded force touch technology; except sensing electrodes, other sensed electrodes are needed in both traditional force touch technology and new embedded force touch technology.

As shown in FIG. 1, force sensing capacitances of the touch display screens are realized by a middle frame 101 of a mobile phone and a back plate 1021 of a backlight module 102; wherein a space 103 existed between the middle frame 101 and the back plate 1021 of the backlight module 102 is usually larger, so that accumulated tolerance of a cover plate, optical glue, frame glue, the liquid panel the backlight module and other portions has smaller affect. However, a space in a capacitor structure of the new force touch technology has even smaller affect and has even higher precision requirement to the space. If the middle frame 101 or the back plate 1021 of the backlight module 1021 is taken as one electrode of the capacitor structure, the accumulated tolerance of the aforementioned portions has a larger affect to the space, and then the traditional space structure cannot match the requirements of the force touch, therefore, the force touch function cannot be achieved to be mass-produced.

### SUMMARY OF THE INVENTION

The present disclosure provides a touch display screen and an electronic apparatus to reduce a affect of accumulated tolerance in space structure and then to enable the embedded force touch display screen to be able to pass-produced.

The present disclosure provides a touch display screen, comprising a middle frame, a liquid crystal panel, a backlight module, a sheet conductor and force sensitive circuits; the liquid crystal panel and the backlight module are fixed within the middle frame, the liquid crystal panel is stacked on the backlight module, and the sheet conductor is stacked on the side of backlight module away from the side of the liquid crystal; wherein, a space is existed between the sheet conductor and the backlight module, the force sensitive circuits are integrated into the liquid crystal panel, and a capacitor structure is formed by both the force sensitive circuits and the sheet conductor.

Wherein the sheet conductor comprises a substrate and an upward bender connected to a side of the substrate, and the sheet conductor is fixedly connected to the liquid crystal panel and/or the backlight module.

Wherein an open formed in rectangular shape is shown on a side of the sheet conductor.

Wherein the substrate of the sheet conductor is stacked on the bottom plate of the middle frame.

Wherein the sheet conductor is made of metal.

Wherein on the sheet conductor, a side facing to the force sensitive circuits is coated with conductive materials.

Wherein the sheet conductor grounds.

Wherein the force sensitive circuits are integrated on a TFT glass of the liquid crystal panel.

Wherein the gap is between 0.15 and 0.25 mm.

The present disclosure further provides an electronic apparatus comprising every aforementioned condition of the touch display screen.

Compare to the present technology, the touch display screen according to the present disclosure, a sheet conductor is added between the backlight module and the middle frame, a capacitor structure is formed of the sheet conductor and the force sensitive circuits integrated within the liquid crystal panel; therefore, a space between the sheet conductor and the backlight module is mainly affected by the tolerance of the backlight module and the sheet conductor, but not affected by the accumulated tolerance of the cover plate, optical glue, and frame glue; thus, the precision requirement of the space can be guaranteed to match the requirement from force touch technology and to be mass produced.

### BRIEF DESCRIPTION OF THE DRAWINGS

In order to more clearly illustrate the present disclosure embodiment or technical solution in the art, the attached drawings, which need to be applied in the present disclosure embodiment or technical description in the art, will be introduced briefly as following. Apparently the attached drawings in the following descriptions only are some embodiments of the present disclosure. As those skilled in the art need not pay any creative work, other drawings are also obtained based on these attached drawing.

FIG. 1 shows a structural schematic diagram of the touch display screen in the art;

FIG. 2 shows a structural schematic diagram of the touch display screen in the present disclosure;

FIG. 3 shows a three-dimensional schematic diagram of a sheet conductor in the first embodiment of the present disclosure;

FIG. 4 shows a three-dimensional schematic diagram of a sheet conductor in the second embodiment of the present disclosure.

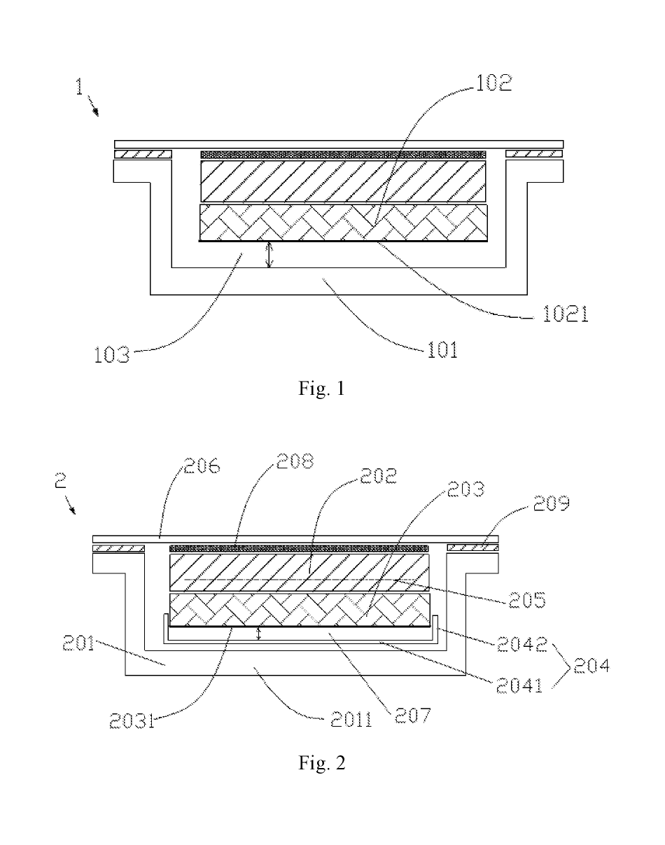

### DETAILED DESCRIPTION OF THE PREFERRED EMBODIMENTS

To make objectives, technical solutions and advantages of the present disclosure more clearer, technical solution in the embodiments of the present disclosure are described clearly and completely in the following with reference to accompanying drawings in the embodiments of the present disclosure. Apparently, the described embodiments are merely part rather than all off the embodiments of the present disclosure. All other embodiments obtained by persons of ordinary skill in the art based on the embodiments of the present disclosure without creative efforts shall fall within the protection scope of the present disclosure.

Please refer to FIG. 2, which is shown a touch display screen 2 according to the present disclosure; the touch display screen 2 comprises a middle frame 201, a liquid crystal panel 202, a backlight module 203, a sheet conductor 204, force sensitive circuits and a cover plate 206; the liquid crystal panel 202 and the backlight module 203 are fixed within the middle frame 201, the liquid crystal panel 202 is stacked on the backlight module 203, and the sheet conductor 204 is stacked on the side of backlight module 202 away from the side of the liquid crystal 202, and is located between the backlight module 203 and the middle frame 201; wherein, a space 207 is existed between a substrate 2041 the sheet conductor 204 and the back plate 2031 of the backlight module 203, the force sensitive circuits 205 are preferably integrated on a TFT glass of the liquid crystal panel 202, and a capacitor structure is formed by both the force sensitive circuits 205 and the sheet conductor 204. The cover plate 206 is fixedly stacked on the liquid crystal panel 202 by a optical glue 208, and is fixedly connected to the middle frame 201 by a frame glue 209. When a use press the cover plate 206, the distance change between the force sensitive circuit 205 and the substrate 2041 of the sheet conductor 204 is occurred to cause the capacitance therein vary; coordinates of the pressing point can be determined by analyzing changes of the capacitance to achieve the force touch on the screens.

The sheet conductor 204 further comprises an upward bender 2042 connected to a side of the substrate 2041, and the sheet conductor 204 is fixedly connected to the liquid crystal panel 202 and/or the backlight module 203. Preferably, the upward bender 2042 is clamped at the TFT glass surrounding of the liquid crystal panel 202, and a gap 207 is preferably between 0.15 and 0.25 mm; the gap is mainly affected by an accumulated tolerance of the backlight module 203 and the sheet conductor 204, but is not affected by an accumulated tolerance of the cover plate 206, the optical glue 208 and the frame glue 209; therefore, the precision requirement of the gap 207 can be guaranteed to match the requirement of the force touch and then the touch display screen 2 can be mass produced.

Furthermore, the sheet conductor 204 is made of metal, or on the sheet conductor 204, a side facing to the force sensitive circuits 205 is coated with conductive materials, and the sheet conductor 204 grounds; therefore an electrode of the above capacitor structure can be formed to achieve the force touch function on the touch display screen 2.

Moreover, the substrate 2041 of the sheet conductor 204 is stacked on the bottom plate 2011 of the middle frame 201; when a user press the cover plate 206, the deformation of the substrate 2041 of the sheet conductor 204 is limited by a bottom 2011 of the middle frame 201; therefore, the precision of the capacitor structure can be further guaranteed.

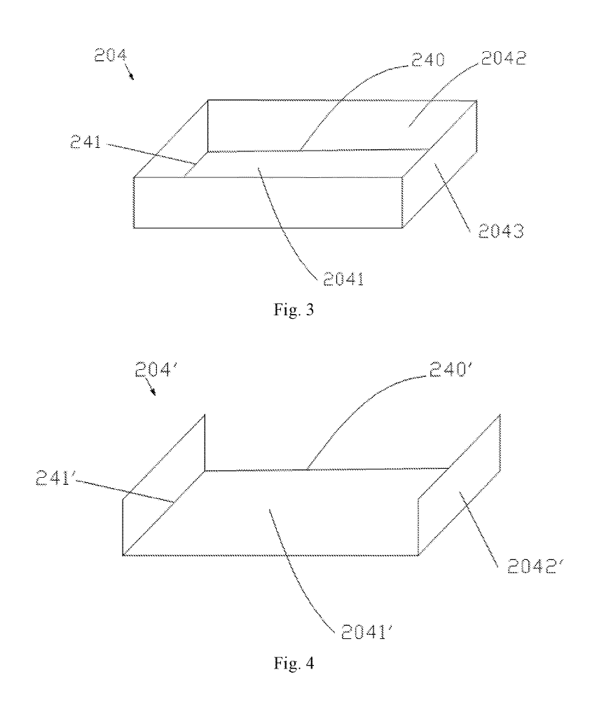

Please refer to the FIG. 3, FIG. 3 shows a three-dimensional schematic diagram of a sheet conductor in the first embodiment of the present disclosure; an open formed in rectangular shape is shown on a side of the sheet conductor 204, and the sheet conductor 204 comprises the substrate 2041, a pair of first outward benders 2042 disposed with respect to one another and a pair of second outward benders 2043 disposed with respect to one another; the substrate comprises a pair of long sides 240 disposed with respect to one another and a pair of short sides 241 disposed with respect to one another, the pair of the first outward benders 2042 are connected to the pair of the long sides respectively, the pair of the second outward benders 2043 are connected to the pair of short sides 241 respectively, and the sheet conductor 204 can be clamped on the liquid crystal panel 202 and/or the backlight module 203 through the pair of the first outward benders 2043 and the pair of the second outward benders 2043; therefore, it can be assured to the fixed connections between the sheet conductor 204 and the liquid crystal panel 202 and/or the backlight module 203.

Please refer to the FIG. 4, FIG. 4 shows a three-dimensional schematic diagram of a sheet conductor 204′ in the first embodiment of the present disclosure. The sheet conductor 204′ is formed in U shape, and the sheet conductor 204′ comprises a substrate 2041′ and a pair of outward benders 2042′ disposed with respect to one another; the substrate 2041′ comprises a pair of long sides 240′ disposed with respected to one another and a pair of short sides 241′ disposed with respected to one another; the pair of outward benders 2042′ are connected to the pair of short sides 241′ of the substrate 2041′ respectively; And the sheet conductor 204′ is clamped between the liquid crystal panel 202 of the touch display screen and/or the backlight module 203 through the pair of the outward benders 2042′. Therefore, the fixed connections between the sheet conductor 204′ and the liquid crystal panel 202 and/or the backlight module 203 can be guaranteed; in other words, using only a structure of a pair of outward benders can save materials using in the sheet conductor 204′.

Of course, according to the specific demands, a pair of outward benders 2042′ can further be connected to the long sides 240′ of the substrate 240′ respectively.

The above embodiments are merely provided for elaborating the technical solution, but not intended to limit the technical solution. Modifications, equivalent substitutions and improvements made within the spirit and principle of embodiments should fall within the protection scope of the technical solution.

What is claimed is:

1. A touch display screen, comprising a middle frame, a liquid crystal panel, a backlight module, a sheet conductor and force sensitive circuits; the liquid crystal panel and the backlight module are fixed within the middle frame, the liquid crystal panel is stacked on the backlight module, and the sheet conductor is stacked on the side of backlight module away from the side of the liquid crystal; wherein, a space is existed between the sheet conductor and the backlight module, the force sensitive circuits are integrated into the liquid crystal panel, and a capacitor structure is formed by both the force sensitive circuits and the sheet conductor.

2. The touch display screen of claim 1, wherein the sheet conductor comprises a substrate and an upward bender connected to a side of the substrate, and the sheet conductor is fixedly connected to the liquid crystal panel and/or the backlight module by the upward bender.

3. The touch display screen of claim 2, wherein an open formed in rectangular shape is shown on a side of the sheet conductor.

4. The touch display screen of claim 3, wherein the substrate of the sheet conductor is stacked on the bottom plate of the middle frame.

5. The touch display screen of claim 4, wherein the sheet conductor is made of metal.

6. The touch display screen of claim 4, wherein on the sheet conductor, a side facing to the force sensitive circuits is coated with conductive materials.

7. The touch display screen of claim 5, wherein the sheet conductor grounds.

8. The touch display screen of claim 6, wherein the sheet conductor grounds.

9. The touch display screen of claim 8, wherein the force sensitive circuits are integrated on a TFT glass of the liquid crystal panel.

10. The touch display screen of claim 8, wherein the gap is between 0.15 and 0.25 mm.

11. An electronic apparatus comprising a touch display screen, wherein the touch display screen, comprises a middle frame, a liquid crystal panel, a backlight module, a sheet conductor and force sensitive circuits; the liquid crystal panel and the backlight module are fixed within the middle frame, the liquid crystal panel is stacked on the backlight module, and the sheet conductor is stacked on the side of backlight module away from the side of the liquid crystal; wherein, a space is existed between the sheet conductor and the backlight module, the force sensitive circuits are integrated into the liquid crystal panel, and a capacitor structure is formed by both the force sensitive circuits and the sheet conductor.

12. The electronic apparatus of claim 11, wherein the sheet conductor comprises a substrate and an upward bender connected to a side of the substrate, and the sheet conductor is fixedly connected to the liquid crystal panel and/or the backlight module.

13. The electronic apparatus of claim 12, wherein an open formed in rectangular shape is shown on a side of the sheet conductor.

14. The electronic apparatus of claim 13, wherein the substrate of the sheet conductor is stacked on the bottom plate of the middle frame.

15. The electronic apparatus of claim 14, wherein the sheet conductor is made of metal.

16. The electronic apparatus of claim 14, wherein on the sheet conductor, a side facing to the force sensitive circuits is coated with conductive materials.

17. The electronic apparatus of claim 15, wherein the sheet conductor grounds.

18. The electronic apparatus of claim 16, wherein the sheet conductor grounds.

19. The electronic apparatus of claim 18, wherein the force sensitive circuits are integrated on a TFT glass of the liquid crystal panel.

20. The electronic apparatus of claim 18, wherein the gaps is between 0.15 and 0.25 mm.
